(19) United States
(12) Patent Application Publication
(10) Pub. No.: US 2003/0141710 A1
(43) Pub. Date: Jul. 31, 2003

(54) Flow-guiding device for guiding at least one gas flow for filling an airbag, and airbag module

(76) Inventors: Matthias Zahn, Stockstadt (DE); Sonja Rausch, Waldaschaff (DE); Thomas Webert, Habichthal (DE); Thomas Zoller, Monchberg (DE)

Correspondence Address: FOLEY AND LARDNER, SUITE 500, 3000 K STREET NW, WASHINGTON, DC, 20007, US

(21) Appl. No.: 10/204,480

(22) PCT Filed: Feb. 9, 2001
(86) PCT No.: PCT/DE01/00554

(30) Foreign Application Priority Data
Feb. 22, 2000 (DE) 200 03 652.1

(51) Int. Cl. B60R 21/26

(52) U.S. Cl. 280/742

(57) ABSTRACT

The invention relates to a flow-guiding device for guiding at least one gas flow for filling an airbag of an airbag module. According to the invention, at least one connecting means (32) is provided for feeding an external gas flow originating from an external source to a generator gas flow originating from a gas generator.

The invention relates to a flow-guiding device for guiding at least one gas flow for an airbag according to the preamble of claim 1 and to an airbag module according to claim 17.

In the event of accident, an airbag, in particular for a motor vehicle, is inflated in a very short time by means of a gas generator, in order to protect occupants from a violent impact against parts of the motor vehicle.

There is the problem, here, of achieving a minimum necessary service life of the inflated airbag, so that the airbag does not collapse too quickly.

After the inflation of the airbag, the gas cools, so that the pressure in the airbag falls. The power of the gas generator must be designed such that, even at the lowest predetermined temperature of use, a sufficient pressure is maintained over the required service life. Owing to the heavy-duty design which is necessary, the overall weight of the gas generator is increased. This means, furthermore, that the airbag is inflated to a very full degree at the maximum temperature of use, so that the seams and the fabric have to be designed for this load.

The object on which the present invention is based is to provide a flow-guiding device and an airbag module, by means of or in which the service life of the airbag is improved and a simple form of construction is obtained.

This object is achieved, according to the invention, by means of a flow-guiding device having the features of claim 1.

What is achieved by using at least one connection means for feeding an external gas flow originating from an external source to a generator gas flow originating from a gas generator is that an additional volume flow is guided into the airbag. The service life of the airbag is therefore improved. Owing to the external source, it is also possible for the gas generator to be dimensioned smaller, since the entire gas volume does not have to originate from the gas generator.

In an advantageous refinement of the flow-guiding device according to the invention, the at least one connection means is designed as an intake connection piece through which the external gas flow is capable of flowing and which constitutes a connection, through which the external gas flow is capable of flowing, between a reservoir or the surrounding air. Such a line affords a particularly simple possibility of providing an additional gas flow for the airbag. In this case, the external gas flow can originate from a reservoir, that is to say a separately provided vessel (for example, with excess pressure), or from the surrounding air.

Advantageously, the flow-guiding device according to the invention has a nonreturn valve for the generator gas flow and/or the external gas flow, said nonreturn valve preventing a backflow. Such a backflow would lead to a pressure loss in the airbag, this being undesirable. In a further advantageous refinement of the flow-guiding device, the nonreturn valve is arranged in the intake connection piece.

In a particularly advantageous refinement of the flow-guiding device, the nonreturn valve has elastic sealing lips which allow a throughflow only during the feed of the external gas flow. A nonreturn valve with elastic sealing lips is constructed in a simple way and can be produced cost-effectively. Advantageously, the sealing lips can be connected to the connection means or are integrally formed on the connection means. These two arrangements can be produced particularly simply.

Likewise advantageously, the flow-guiding device has sealing means for the connection to the gas generator and/or to the diffuser tube. This is intended to prevent pressure losses occurring as a result of leakages. It is advantageous that a sealing means is designed as a labyrinth seal, since this can be produced in a simple way.

An advantageous configuration of the flow-guiding device according to the invention is designed as an essentially T-shaped plastic molding. Such a configuration is advantageous when the generator gas flow is to experience a right-angled direction change, such as, for example, when a tubular gas generator is used. Using a plastic molding, even complex geometric shapes of the flow-guiding device can be formed. It is particularly advantageous, at the same time, if the intake connection piece is arranged on the essentially T-shaped plastic molding, since this makes particularly simple and compact manufacture possible.

To make it easier to mount the flow-guiding device together with the remaining airbag module, it is advantageous that the flow-guiding device according to the invention has two components connectable to one another, the components being connected to one another in the assembled state at the gas generator and/or diffuser tube. The components can thus first be attached separately to the gas generator and/or the diffuser tube, in order, for example, to compensate existing tolerances. When alignment has been carried out, the components are connected to one another during assembly and then form the flow-guiding device. It is advantageous, in this case, that the components can be held together by means of a clip.

For easier mounting, it is advantageous if the clip is designed to be lockable. Thus, the parts connected to the flow-guiding device can be connected with play by means of a loosely locked clip. During final mounting, the play is used to compensate manufacturing tolerances. Only then is the clip tightened firmly, in order to achieve the final state.

It is advantageous, at the same time, if the intake connection piece is arranged on one of the components, so that there are no joints at the intake connection piece.

To avoid leakages, it is also advantageous to provide component sealing means which are arranged where the components are in contact with one another when assembled.

The object is also achieved by means of an airbag module having the features of claim 17. Using an external gas flow in addition to the generator gas flow, the pressure in the airbag can be maintained for a longer period.

The invention is explained in more detail below by means of several exemplary embodiments with reference to the figures of the drawings in which:

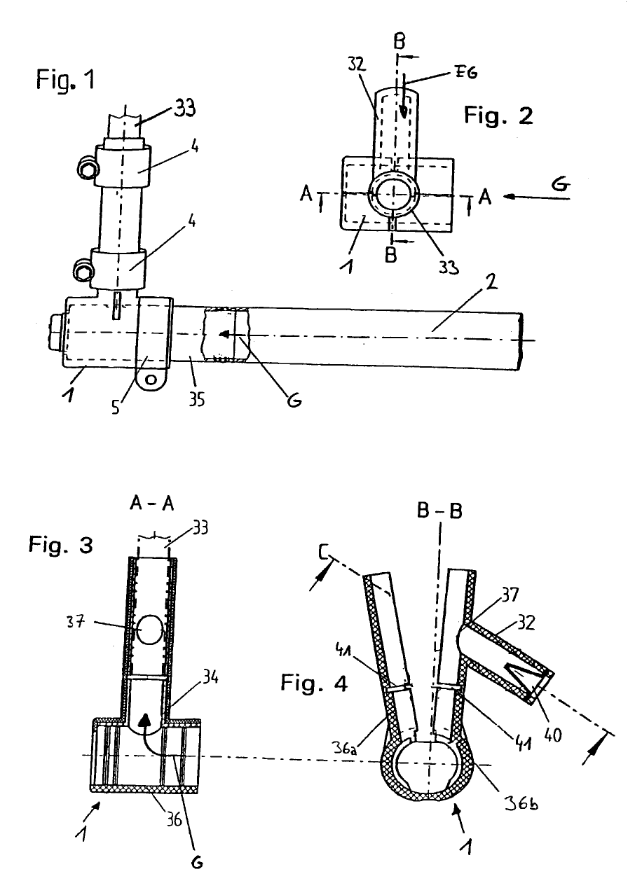

FIG. 1 shows a side view of the flow-guiding device according to the invention for guiding a generator gas flow, in conjunction with a tubular gas generator;

FIG. 2 shows a top view of the flow-guiding device according to the invention with an intake connection piece;

FIG. 3 shows a sectional view of the flow-guiding device according to the invention along the line A-A in FIG. 2;

FIG. 4 shows a sectional view of the flow-guiding device according to the invention along the line B-B in FIG. 2, the flow-guiding device being produced in one piece with a hinge;

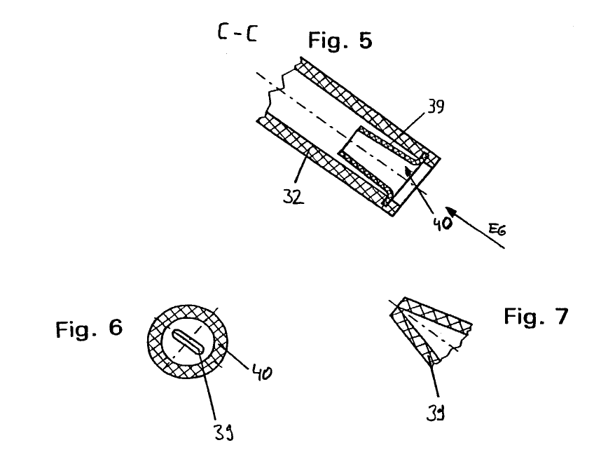

FIG. 5 shows a sectional view of a detail of an intake connection piece with a nonreturn valve in FIG. 4 along the line C-C in FIG. 4;

FIG. 6 shows a top view of a closed nonreturn valve in the intake connection piece;

FIG. 7 shows a sectional view of a closed nonreturn valve;

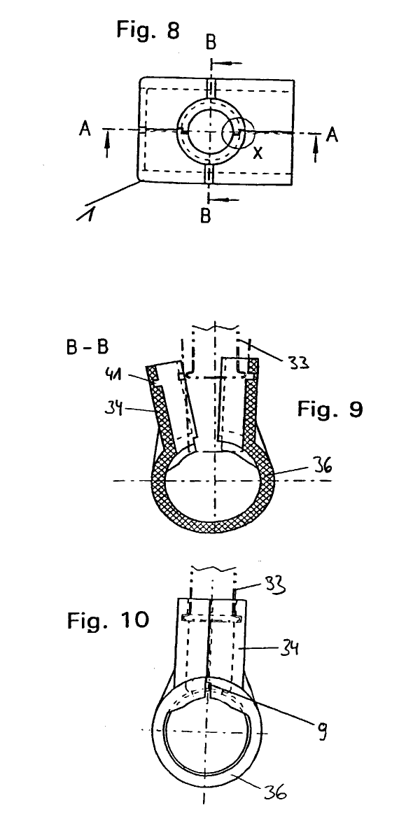

FIG. 8 shows a side view of an embodiment of the flow-guiding device according to the invention with labyrinth seals;

FIG. 9 shows a sectional view of the embodiment illustrated in FIG. 8, along the line B-B in FIG. 8;

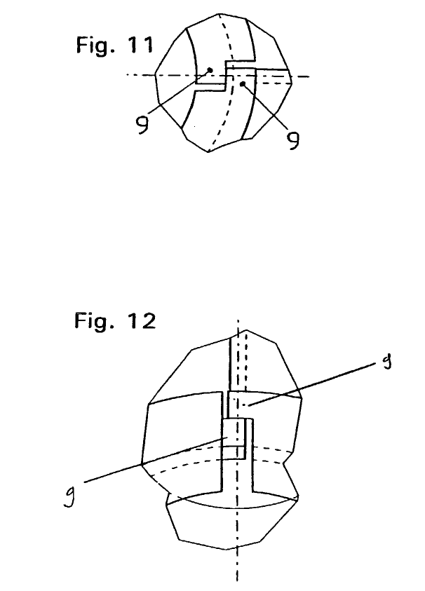

FIG. 10 shows a side view of the embodiment illustrated in FIG. 8, with a labyrinth seal;

FIG. 11 shows a view of a detail of the labyrinth seal (detail X from FIG. 8);

FIG. 12 shows a view of a detail of the labyrinth seal from FIG. 10;

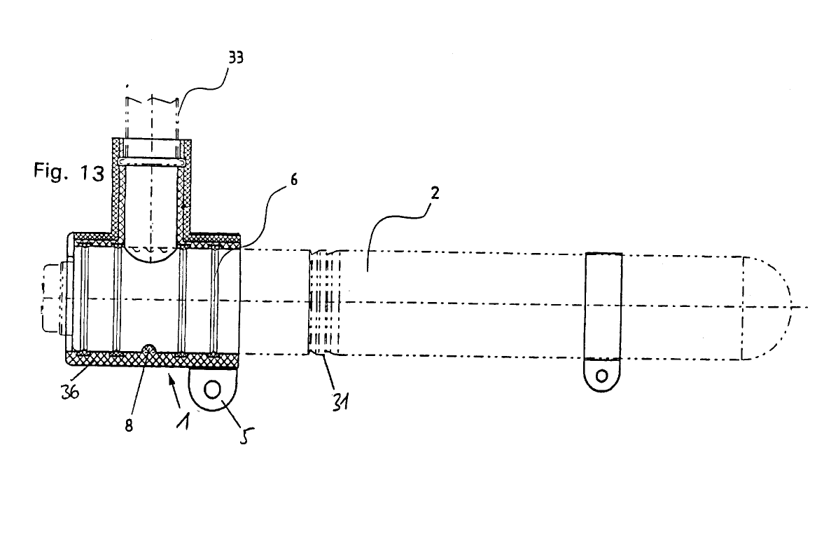

FIG. 13 shows a sectional view of the flow-guiding part according to the invention along the line A-A in FIG. 8 and the tubular gas generator.

FIGS. 1 and 13 illustrate the flow-guiding device 1 according to the invention for at least one flow for filling an airbag, in cooperation with a tubular gas generator 2, of an airbag module, not illustrated here, for motor vehicles.

The tubular gas generator 2 has an orifice which points to the left in FIG. 1 and can be seen in the cutaway through which flows a generator gas flow G directed to the left in the figure. The generator gas flow G is guided at right angles by the flow-guiding device 1 according to the invention for guiding the filling-gas flow, where said generator gas flow passes into the airbag via a diffuser tube 33 illustrated only partially. The diffuser tube 33 is connected to the flow-guiding device 1 by diffuser tube clips 4.

In the installed state, the flow-guiding device 1 according to the invention is connected to the body by means of a clip 5. Since the gas generator 2 and the flow-guiding device 1 according to the invention are manufactured at a different location from where the airbag module is installed in the motor vehicle, the clip 5 is designed to be lockable, in order to hold the parts together relatively loosely in the premounted state. During final mounting, that is to say when the clip 5 is firmly tightened, the manufacturing tolerances occurring in the individual instance are then compensated by a fitter.

FIG. 2 illustrates a top view of the flow-guiding device 1 according to the invention, edges arranged inside the flow-guiding device 1 being illustrated by broken lines. This illustrates that an intake connection piece 32 is provided as a connection means 32 for feeding an external gas flow EG (see the direction of the arrow) to the generator gas flow G. The external gas flow EG and the generator gas flow G form a filling-gas flow of the airbag.

The geometric conditions inside the flow-guiding device 1 are illustrated in the sectional view of FIG. 3 (section along A-A in FIG. 2). In the example illustrated here, the flow-guiding device 1 according to the invention is formed from an essentially T-shaped component, referred to below as T-piece 36. The intake connection piece 32 is arranged on the T-piece 36. The T-piece 36 and the intake connection piece 32 together form a flow-guiding device 1 for guiding the filling-gas flow.

The diffuser tube 33 (depicted by dashes and dots) is arranged, here, in the upwardly pointing basic tube 34 of the T-piece 36. An inflow point 37 makes a connection with the intake connection piece 32.

In the event that the airbag is triggered, the generator gas flow G flows at high velocity through the basic tube 34, past the inflow point 37, into the diffuser tube 33. As a result of the flow of the gas generator flow G in the basic tube 34, a vacuum is generated in the intake connection piece 32 according to Bernoulli's law (principle of the jet pump), so that the external gas flow EG is sucked in. Since the intake connection piece 32 projects at its free end into the surrounding air, air is sucked in here. In principle, however, it is also conceivable to have reservoirs, to which there one end of the intake connection piece 32 is connected.

The entrained air quantity of the external gas flow EG is mixed with the generator gas flow G, so that both pass as the filling-gas flow into the airbag.

In alternative embodiments, the intake connection piece 32 is integrally formed on the diffuser tube 33 which is connected to the T-piece 36. The flow-guiding device 1 according to the invention would then consist of the T-piece 36 and of the diffuser tube 33.

FIG. 4 shows a nonreturn valve 40 which is arranged in the intake connection piece 32. This serves for preventing a backflow of the filling-gas flow (generator gas flow G and external gas flow EG) through the intake connection piece 32 into the surroundings. Such a backflow would lead to an undesirable pressure drop in the airbag.

If the ambient temperature is relatively high, a higher pressure is generated relatively quickly in the airbag, so that the filling-gas flow into the airbag decreases. The external gas flow EG thereby also decreases, so that an overfilling of the airbag is avoided. At relatively low ambient temperatures, the filling-gas flow is maintained for a longer time, since the counterpressure of the airbag does not rise so quickly. More air is therefore sucked in as the external gas flow EG. The volume flow of the external gas flow EG is thus regulated automatically.

FIG. 4 illustrates an embodiment of the flow-guiding device according to the invention which is simple to mount. The T-piece 36 is produced as a plastic molding which has a first component 36a and a second component 36b which are connected moveably to one another via a hinge. The components 36a, 36b, when assembled, form the basic tube 34 of the T-piece 36. The intake connection piece 32 is integrally formed onto the second component 36b.

The left half of FIG. 4 illustrates the first component 36a as being placed, for mounting, around part of the gas generator 2, not illustrated here. During mounting, the second component 36b is shaped in a similar way.

The two components 36a, 36b are subsequently bent together, so that the T-piece 36 is obtained. This is then held together by means of clips 4.

Inside the components 36a, 36b are arranged grooves 41 which serve for receiving a flange on the diffuser tube 33, not illustrated here.

After final mounting, the diffuser tube 33 and the gas generator 2 are firmly connected to one another without a threaded connection via the flow-guiding device 1.

The plastic molding is produced, here, as an injection molding. Alternatively, a two-component technology or blow-forming may also be used.

FIG. 5 illustrates a detail of the nonreturn valve 40 which is arranged in the intake connection piece 32. The nonreturn valve 40 is produced, here, from an elastic material and has an orifice delimited by sealing lips 39. In the view illustrated, the sealing lips 39 are drawn apart, since the external gas flow EG presses them open. This corresponds to the previously illustrated intake of external air by the generator gas flow G. The sealing lips 39 are designed to be not too elastic, in order to allow overturning in the other direction.

FIG. 6 illustrates a top view of the nonreturn valve 40 in the axial direction. Here, the sealing lips 39 are closed, since a counterpressure from the airbag closes the sealing lips 39. FIG. 7 illustrates a detail of the closed sealing lips 39.

FIG. 8 illustrates a top view of a T-piece 36 which has two components in a similar way to that shown in FIG. 4. Here, in addition, labyrinth seals 9 (see also FIG. 11 and 12) are provided, which ensure sealing-off relative to the diffuser tube 33, not illustrated here.

In FIG. 9, the diffuser tube 33 is indicated by the thin lines, a peripheral flange of the diffuser tube 33 engaging into grooves 41 of the T-piece 36 when the T-piece 36 consisting of the two components is closed.

FIG. 10 shows a side view of the T-piece 36 from FIG. 8.

FIG. 11 illustrates a view of a detail of the labyrinth seal 9 in FIG. 9 in a top view. The offset in the labyrinth seal 9 increases the sealing action. FIG. 12 shows a view of a detail of the labyrinth seal 9 in side view.

FIG. 13 shows a view of a T-piece 36 which is connected to the tubular gas generator 2. The T-piece 36 in this case surrounds the tubular gas generator 2, sealing means 6 ensuring sealing-off. The T-piece 36 has a tenon-shaped or cap-shaped positioning means 8 which engages into a corresponding depression of the tubular gas reactor [sic] 2. This positioning means 8 ensures a simple axial and radial alignment of the parts during assembly.

The invention has been illustrated here in connection with a tubular gas generator. In alternative embodiments of the invention, other gas generators are used.

The invention is not restricted in its implementation to the preferred exemplary embodiments specified above. On the contrary, a number of variants are conceivable, which make use of the flow-guiding device according to the invention and of the airbag module according to the invention, even in versions which are fundamentally of a different type.

1. A flow-guiding device for guiding at least one gas flow for filling an airbag of an airbag module, characterized by at least one connection means (32) for feeding an external gas flow (EG) originating from an external source to a generator gas flow (G) originating from a gas generator (2).

2. The flow-guiding device as claimed in claim 1, characterized in that the at least one connection means (32) is designed as an intake connection piece, through which the external gas flow (EG) is capable of flowing and which constitutes a connection, through which the external gas flow (EG) is capable of flowing, between a reservoir or the surrounding air.

3. The flow-guiding device as claimed in claim 1 or 2, characterized by a nonreturn valve (40) for the generator gas flow (G) and/or the external gas flow (EG).

4. The flow-guiding device as claimed in claim 3, characterized in that the nonreturn valve (40) is arranged in the intake connection piece (32).

5. The flow-guiding device as claimed in claim 3 or 4, characterized in that the nonreturn valve (40) has elastic sealing lips (39) which allow a throughflow only during the feed of the external gas flow (EG).

6. The flow-guiding device as claimed in claim 5, characterized in that the elastic sealing lips (39) can be connected to the connection means (32).

7. The flow-guiding device as claimed in claim 5, characterized in that the elastic sealing lips (39) are integrally formed on the connection means (32).

8. The flow-guiding device as claimed in at least one of the preceding claims, characterized by sealing means (6, 9) for connection to the gas generator (2) and/or to the diffuser tube (33).

9. The flow-guiding device as claimed in claim 8, characterized in that a sealing means is designed as a labyrinth seal (9).

10. The flow-guiding device as claimed in at least one of the preceding claims, characterized in that it is produced as an essentially T-shaped plastic molding (36).

11. The flow-guiding device as claimed in claim 10, characterized in that the intake connection piece (32) is arranged on the essentially T-shaped plastic molding (36).

12. The flow-guiding device as claimed in at least one of the preceding claims, characterized in that it has two components (36a, 36b) connectable to one another, the components (36a, 36b) being connected to one another in the assembled state at the gas generator (2) and/or the diffuser tube (33).

13. The flow-guiding device as claimed in claim 12, characterized in that the components (36a, 36b) can be held together by means of a clip (5).

14. The flow-guiding device as claimed in claim 13, characterized in that the clip (5) is designed to be lockable.

15. The flow-guiding device as claimed in at least one of claims 13 to 15, characterized in that the intake connection piece (32) is arranged on one of the components (36a, 36b).

16. The flow-guiding device as claimed in at least one of claims 12 to 15, characterized by component sealing means which are arranged where the components (36a, 36b) are in contact with one another when assembled.

17. An airbag module, in particular with a tubular gas generator having a flow-guiding device as claimed in at least one of claims 1 to 16.
